(19) United States
(12) Patent Application Publication
(10) Pub. No.: US 2013/0045695 A1
(43) Pub. Date: Feb. 21, 2013

(54) TRANSMITTING AND RECEIVING RADIO SIGNALS IN VARIOUS FREQUENCY RANGES

(71) Applicants: Helmut Nast, Berlin (DE); Ronald Heldt, Rangsdorf (DE); Rainer Holz, Berlin (DE); Thomas Bartsch, Zossen Ot Dabendorf (DE)

(72) Inventors: Helmut Nast, Berlin (DE); Ronald Heldt, Rangsdorf (DE); Rainer Holz, Berlin (DE); Thomas Bartsch, Zossen Ot Dabendorf (DE)

(73) Assignee: FUNKWERK DABENDORF GMBH, DABENDORF (DE)

(21) Appl. No.: 13/695,066

(22) PCT Filed: Apr. 19, 2011
(86) PCT No.: PCT/EP11/56255

§ 371 Date: Oct. 29, 2012

(30) Foreign Application Priority Data
Apr. 27, 2010 (DE) 10 2010 018 509.4

(51) Int. Cl. H04B 1/44

(52) U.S. Cl. 455/78

(57) ABSTRACT

A device transmits and receives radio signals, in particular radio signals in a cellular radio network. The device contains a first transmitting antenna for transmitting radio signals and a second receiving antenna. The antennas transmit and/or receive radio signals in different frequency ranges. The antennas are connected to a common cable connection via a radio signal splitter, by which cable connection the device can be connected to a radio terminal. The device contains a first radio signal amplifier disposed in a first radio signal path and/or a second radio signal amplifier disposed in a second radio signal path. The transmitting antenna and the receiving antenna have attenuation with respect to feedback of a radio signal transmitted from the transmitting antenna to the receiving antenna due to the arrangement thereof relative to each other and due to the transmitting and/or receiving characteristics thereof.

The invention relates to a device for transmitting and receiving radio signals, a method for operating the device and a manufacturing method for manufacturing the device. The radio signals are, in particular, radio signals in a cellular radio network such as UMTS, LTE and/or GSM. The invention relates in particular to the area of setting up and maintaining a radio link between a radio terminal device and the radio network.

Radio terminal devices, mobile telephones, emergency call transmitters, radio transmitters (e.g. USB sticks, which are connected via a USB interface to the computer in order to connect the latter to a UMTS network) for the connection of computers to radio networks are normally able to communicate directly with the radio network via a built-in transmit and receive antenna. However, there are situations in which the connection quality is very poor or a connection is even impossible. For example, such situations frequently occur within buildings. One reason for this is that building parts and/or adjacent buildings hinder the transmission of the radio signals.

One possibility for improving the quality of the radio link or actually making a radio link possible is the use of additional antennas. If an additional antenna of this type has, for example, a higher antenna gain than the antenna built into the radio terminal device, the communication between the terminal device and the radio network can be improved. Furthermore, it is possible to set up the additional antenna at a suitable location from which a better radio link to the radio network is possible than from many other locations, e.g. from locations far inside the building. The radio signal link between the additional antenna and the terminal device can be implemented via cables and/or radio paths. For example, the terminal device can be coupled to the additional antenna via a wireless coupling of its transmit and receive antenna to a coupling antenna, wherein the coupling antenna is in turn connected via an antenna cable to the additional antenna. In principle, however, this is also directly possible via an antenna cable plug-in connection on the terminal device. In all cases, the same protocols for transmitting signals, e.g. Bluetooth, WLAN protocols, etc., can be used via the connection between the terminal device and the additional antenna and between the additional antenna and the remote radio stations, although cables can be used between the terminal device and the additional antenna.

Modern radio terminal devices are able to set up and maintain radio links in various frequency ranges and into various radio networks. In Germany, for example, radio networks are operated according to the GSM (Global System for Mobile Communication) in frequency ranges around 900 MHz and also around 1800 MHz. Furthermore, radio networks are operated according to UMTS (Universal Mobile Telecommunication System) at frequencies around 2100 MHz. The LTE (Long Term Evolution) suitable for even higher data transmission rates will, for example, be offered in Germany in future at frequencies around 800 MHz and around 2500 MHz in cellular radio networks.

The use of a single additional antenna for the various mobile radio network types and frequency ranges is, however, disadvantageous for various reasons. On the one hand, the antenna gain changes with the frequency, i.e. the antenna is not normally suited or equally well suited for all frequency ranges. Furthermore, the network coverage, i.e. in particular the cell density, of the various radio networks is different. Radio networks that have been in existence for some time and are used by more subscribers typically have a greater cell density. If the communication to one cell of the radio network is not or is no longer sufficient, a different cell with better transmission quality is normally available. On the other hand, it frequently occurs in younger radio networks, in particular in UMTS and LTE networks, that even the radio link to the cell with the best transmission quality is of much poorer quality than in other radio networks at the same location. Moreover, UMTS and LTE are designed for significantly higher maximum transmission rates than GSM. However, with lower signal quality, the maximum transmission rates are far from attainable.

One possibility for dealing with these different availabilities and qualities of the various radio networks is the use of more than one additional antenna. However, a plurality of various couplings of the radio terminal devices to the various antennas can increase the technical outlay and costs in such a way that only a small number of users are interested therein.

One object of the present invention is to indicate a device which enables a communication to the various radio networks with good quality at low cost for the connection of the radio terminal device to an additional antenna or a plurality of additional antennas.

According to one basic idea of the present invention, the device has a common connection for the coupling of the radio terminal device, via which a plurality of antennas, which are provided in each case for communication in a different frequency range, are connected. In particular, the antennas are connected via a radio signal filter to the common connection. The radio signal filter may, for example, be a splitter/combiner. In the case of division of the radio signals which are transmitted from the radio terminal device to the antennas, a device of this type is referred to as a splitter. In the case of transmission of radio signals which the individual antennas have received to the radio terminal device, a device of this type is referred to as a combiner. A splitter/combiner has the advantage that communication can take place simultaneously in various frequency ranges, and that the outlay to operate the device is low, since no switching processes are required. However, a disadvantage of the splitter function is that the radio signal strength in the individual radio signal paths from the splitter to the antennas is lower than on the common radio signal connection.

According to a further basic idea of the invention, this reduction in the signal strength is, however, compensated for in at least one of the radio signal paths by a transmit amplifier. However, the transmit signal amplifier can, in particular, also compensate, or even overcompensate, for losses (attenuation) which occur on the whole due to the coupling of the radio terminal device to the respective transmit antenna. In particular, cable connections, radio paths and the components of the device which are used contribute to such losses. In the case of a cable connection and in the case of a wireless coupling of the radio terminal device via an antenna near-field coupling to the connection cable to the device or directly to the common connection of the device, it is preferred that the attenuation thereby caused has a fixed, predefined value or a value settable or definable as one-off in relation to a specific radio terminal device, and that the antenna amplification of the transmit signal amplifier is set or settable accordingly in advance in such a way that this attenuation is at least balanced out, i.e. compensated for. On the other hand, however, signal transmission paths between the radio signal filter and the individual antennas which are used for the transmission to radio networks or from radio networks with a high cell density, i.e., in particular, good signal quality, can get by without amplifiers.

If a transmit signal amplifier is involved here, it is preferred that a receive amplifier is also disposed in the same radio signal path between the radio signal filter and the antenna.

The arrangement of the transmit signal amplifier and receive signal amplifier in a radio signal path between a specific antenna and the radio signal filter has the advantage that the amplifier(s) can be designed specifically for the amplification of radio signals in the frequency range in which the antenna transmits and/or receives signals. A single-band amplifier of this type can be cheaper and/or more powerful at the same cost than an amplifier for a plurality of frequency ranges or particularly wide frequency ranges.

According to a further idea of the present invention, signal transmission paths which are not equipped in advance with a radio signal amplifier can be optionally retrofittable. This is appropriate in situations in which a signal transmission with unexpectedly poor signal quality takes place in the respective signal transmission path. For example, a signal transmission path for GSM 900 can be retrofitted with a retrofit amplifier of this type in a rural area.

A further aspect of the present invention relates to the fault-free operation of the various antennas and radio signal paths simultaneously. Particularly in the case of the aforementioned splitter/combiner, a feedback of antenna signals which have been transmitted by an antenna can take place to a different antenna of the device, even if only one of the signal paths is to be operated.

The device is therefore to be designed in particular in such a way that a feedback of this type does not result in a resonance excitation in which the fed back signals are again amplified and again fed back, resulting in very high amplitudes.

A device is therefore proposed in which the transmit antenna, which transmits the possibly fed back signals, and the receive antenna, which can receive the transmitted signals, are disposed relative to one another in such a way and are designed on the basis of their transmit and/or receive characteristic in such a way that the transmit antenna and the receive antenna have an attenuation (which can also be referred to as isolation) in relation to one another which is greater than the amplification gain of the amplifiers involved in a possible feedback of this kind, minus the attenuation which the radio signal filter has in relation to a crosstalk of the signals between the radio signal paths. In other words, the sum of the attenuations for the crosstalk of signals between the antennas and for the crosstalk of the signals from the radio signal path of the receive antenna onto the radio signal path of the transmit antenna is greater than the amplification gain of the amplifiers involved. The amplifiers involved are, in particular, the transmit amplifier in the radio signal path to the transmit antenna and any receive amplifier in the radio signal path of the receive antenna. A radio signal path is in each case understood to be the signal path which extends between the antenna and the common radio signal filter.

The radio signal filter does not have to be a single component. Instead, a radio signal filter of this type can also be constructed from a plurality of components for more than two antennas. For example, splitter/combiner facilities can be cascaded with two antenna-side connections for two antennas and one terminal-device-side connection for the common signal connection, so that more than two antennas are connected to the common signal connection.

In particular, the following device is proposed:

A device for transmitting and receiving radio signals in a cellular radio network such as UMTS, LTE, and/or GSM, wherein
the device has at least two antennas, of which a first antenna is designed as a transmit antenna for transmitting radio signals and at least one other, second antenna is designed as a receive antenna for receiving radio signals,
the antennas are designed for transmitting and/or receiving radio signals in each case in a different frequency range,
each of the antennas is connected via a radio signal filter to a common cable connection via which the device is connectable to a radio terminal device,
the device has at least one radio signal amplifier, wherein
   a first radio signal amplifier is disposed in a first radio signal path between the radio signal filter and the transmit antenna, and/or
   a second radio signal amplifier is disposed in a second radio signal path between the receive antenna and the radio signal splitter,
the transmit antenna and the receive antenna have an attenuation in relation to a feedback of a radio signal transmitted from the transmit antenna to the receive antenna due to the arrangement thereof relative to one other and due to the transmit and/or receive characteristic thereof, said attenuation being greater than the amplification gain of the first and second radio signal amplifiers, minus an attenuation which the radio signal filter has in relation to a crosstalk of the signals between the radio signal paths.

The transmission/reception is possible in particular in a cellular network such as UMTS, LTE and/or GSM. However, other radio links at least partially or not exclusively designed for cellular radio networks can be operated via the antennas, e.g. in a WLAN (Wireless Local Area Network) or microwave links. Furthermore, any given transmission protocols can be used.

The transmit antenna can optionally also be a receive antenna. Conversely, the receive antenna can optionally also be a transmit antenna. A transmit and receive antenna can therefore optionally be involved. The isolation in relation to the feedback preferably also applies to any other combination of transmit antenna and receive antenna of the device.

The occurrence of an oscillation due to the feedback, i.e. a resonance due to the fed back, received signals, is reliably prevented by the attenuation of the feedback. The normal transmit/receive operation is therefore not disrupted.

In particular, as described above, one of the signal paths between the signal filter and the individual antennas can have no amplifier. For example, the signal path in the receive path of the receive antenna can have no signal amplifier. In this case, the attenuation in relation to the feedback (i.e. crosstalk between the antennas and crosstalk between the radio signal paths) is greater than the amplification gain of the radio signal amplifier in the other signal path. This relates to a pair of antennas and signal paths, i.e. to a transmit antenna and a receive antenna with a transmit signal path and a receive signal path.

In particular, the oscillation due to feedback can also be effectively achieved through a slightly lower attenuation, if the attenuation of the further components of the device which form part of the potential feedback loop is also taken into account. Apart from the signal filter, these components are, in particular, the signal lines in the signal paths between the signal filter and the individual antennas in the transmit signal path and in the receive signal path. It therefore suffices if the attenuation achieved due to the arrangement of the transmit antenna and the receive antenna relative to one another and due to the transmit and/or receive characteristic of the antennas is greater than the amplification gain of the signal amplifiers in the transmit path and receive path, minus the attenuation produced by the aforementioned components in the potential feedback loop.

One of the first and second antennas, i.e. either the transmit antenna or the receive antenna, may be a directional antenna with an antenna gain of more than 5 dBi, preferably more than 7 dBi. In this case, the other antenna is disposed outside the solid-angle range of the directional antenna in which the antenna gain is more than 5 dBi or more than 7 dBi. The other antenna is preferably disposed outside a solid-angle range of the directional antenna in which an antenna gain of the directional antenna is at all effective. However, it is alternatively also possible to dispose the other antenna in a solid-angle range in which an antenna gain of the directional antenna exists, but to shield the other antenna from the directional antenna. An example and a specific embodiment with a reflector will be examined more closely. Generally, the use of a directional antenna with substantial antenna gain and the corresponding alignment of the directional antenna simplifies or itself effects the attainment of the desired attenuation value.

In a preferred embodiment, the directional antenna may be an antenna which has an electrically conducting layer applied onto an even surface of a carrier. An antenna of this type is simple to produce, requires very little structural space in the direction transverse to the surface of the carrier and can be shielded on one side of the carrier, in particular the side which forms the rear side of the electrically conducting layer, and can, in particular, be provided with a reflector. In this way, the other antenna and/or the other components (signal filter, at least parts of the signal paths and/or amplifiers) disposed in the radio signal paths can be disposed on the rear side of the carrier beyond the shielding or the reflector. In this way, unwanted interferences and interactions or influences of the radio signals transmitted by the directional antenna on the other components and signal paths are avoided.

In a specific design, the directional antenna can have an electrically conducting layer structured in such a way that the electrically conducting layer has two strip lines which in each case encircle an area of the surface. The term “encircle” is understood to mean that the strip lines form the outer edge of the respective area, wherein, however, a small part of the outer edge of the area cannot be formed by the respective strip line, so that the strip line does not encircle the area in a closed manner. The shape of an area of this type encircled in a virtually closed manner may vary according to the directional antenna. The area may, for example, be a circular area, a rectangular area or a polygonal area.

As already mentioned, a reflector made from electrically conducting material can be used. In a preferred design, a plate-shaped reflector, which has two parallel large-area surfaces corresponding to the plate shape, is disposed in such a way that the large-area surfaces run parallel to the surface of the carrier onto which the electrically conducting layer of the directional antenna is applied. Seen from the electrically conducting layer, the reflector is located on the rear side of the carrier. Advantages of an arrangement of this type have already been discussed. In particular, seen from the carrier, the other antenna can be disposed on the rear side of the reflector. If more than two antennas are present, further antennas of the device can also be disposed there.

The other antenna may, for example, be a rod antenna or other antenna which, at least in a plane perpendicular to the longitudinal axis of the rod, has a homogeneous receive and transmit characteristic. It is even possible for the rod antenna or other antenna which is disposed on the rear side of the reflector to project beyond the edges of the reflector, so that it is visible from the front side of the reflector. However, due to the directional characteristic and due to the reflector, an adequate attenuation in relation to the feedback is achieved. A projection of this type beyond the edges of the reflector has the advantage that the rod antenna or other antenna can transmit and receive all-round.

However, the large-area surface of the reflector is preferably larger than the surface of the carrier of the electrically conducting layer of the directional antenna. Furthermore, the edge of the reflector preferably projects on all sides, viewed from the front side of the carrier, beyond the edges of the carrier.

Essentially, a directional antenna with the aforementioned antenna gain is well suited to setting up and maintaining a connection to a specific transmit and receive station of a radio cell of a radio network. Even relatively far-distant stations of a radio network can thus be reached. In practice, a far-distant radio station of this type can, for example, be a UMTS radio station or an LTE radio station of a radio network with poor network coverage.

In the case of the reflector, the radio signal path between the radio signal filter and the electrically conducting layer on the surface of the carrier preferably has a radio signal line which is fed through the reflector perpendicular to the large-area surfaces of the reflector. Interferences to the directional antenna on the carrier are avoided due to the perpendicular feed-through.

Furthermore, the scope of the invention includes a method for transmitting and receiving radio signals, in particular using a device as described in the description. In particular a method of this type is proposed, wherein
the device has at least two antennas, of which a first antenna is designed as a transmit antenna to transmit radio signals, and at least one other, second antenna is designed as a receive antenna to receive radio signals,
the antennas transmit and/or receive radio signals in each case in a different frequency range,
radio signals, if they are received at a specific time, are transmitted from the respective antenna via a radio signal filter to a common cable connection of the antennas, or, if they are transmitted at a specific time, are transmitted from the common cable connection via the radio signal filter to the respective antenna,
radio signals are amplified in at least one radio signal path between the radio signal filter and the respective antenna, wherein
   radio signals are amplified in a first radio signal path between the radio signal filter and the transmit antenna by a first radio signal amplifier, and/or
   radio signals are amplified in a second radio signal path between the receive antenna and the radio signal filter by a second radio signal amplifier,
the transmit antenna and the receive antenna cause an attenuation of the radio signals in relation to a feedback of a radio signal transmitted from the transmit antenna to the receive antenna due to the arrangement thereof relative to one another and due to the transmit and/or receive characteristic thereof, said attenuation being greater than the amplification gain of the first and second radio signal amplifiers, minus an attenuation which the radio signal filter has in relation to a crosstalk of the signals between the radio signal paths.

Furthermore, the scope of the invention includes a method for manufacturing a device for transmitting and receiving radio signals, in particular the device in one of the designs described in this description. A method for manufacturing a device is therefore proposed, wherein
at least two antennas are provided, of which a first antenna is designed as a transmit antenna to transmit radio signals, and at least one other, second antenna is designed as a receive antenna to receive radio signals, and the antennas are directly and/or indirectly mechanically interconnected,
the antennas are designed to transmit and/or receive radio signals in each case in a different frequency range,
each of the antennas is connected via a radio signal filter to a common cable connection, via which the device is connectable to a radio terminal device,
at least one radio signal amplifier is provided, wherein
   a first radio signal amplifier is disposed in a first radio signal path between the radio signal filter and the transmit antenna, and/or
   a second radio signal amplifier is disposed in a second radio signal path between the receive antenna and the radio signal filter,
the transmit antenna and the receive antenna, in relation to a feedback of a radio signal transmitted from the transmit antenna to the receive antenna, are disposed relative to one another and designed in such a way that they have an attenuation which is greater than the amplification gain of the first and second radio signal amplifiers, minus an attenuation which the radio signal filter has in relation to a crosstalk of the signals between the radio signal paths.

Example embodiments of the invention will now be described with reference to the attached drawing. In the individual figures of the drawing:

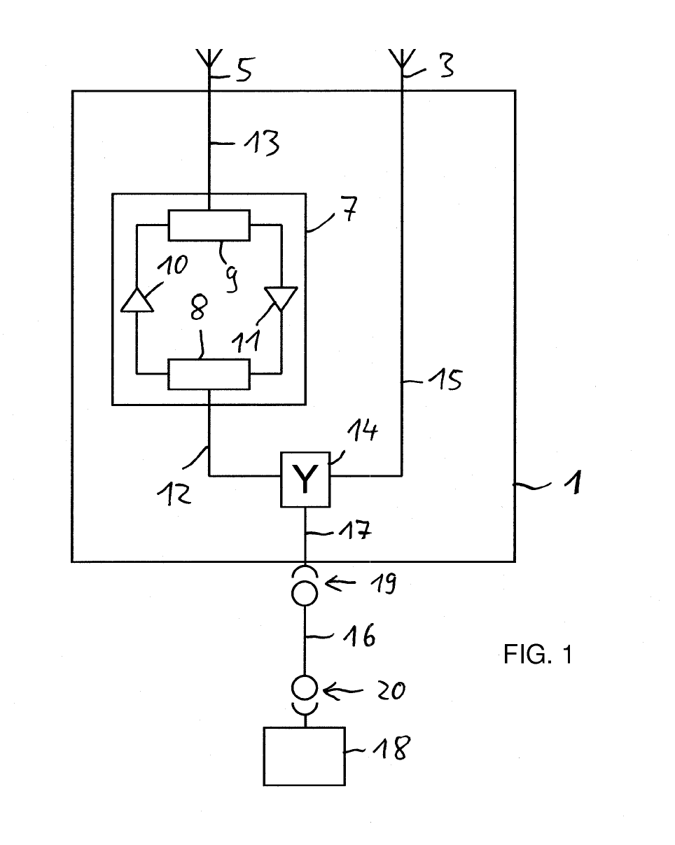

FIG. 1 shows a circuit diagram of a device according to the invention and, in addition, a facility for coupling a radio terminal device via a cable connection to the device,

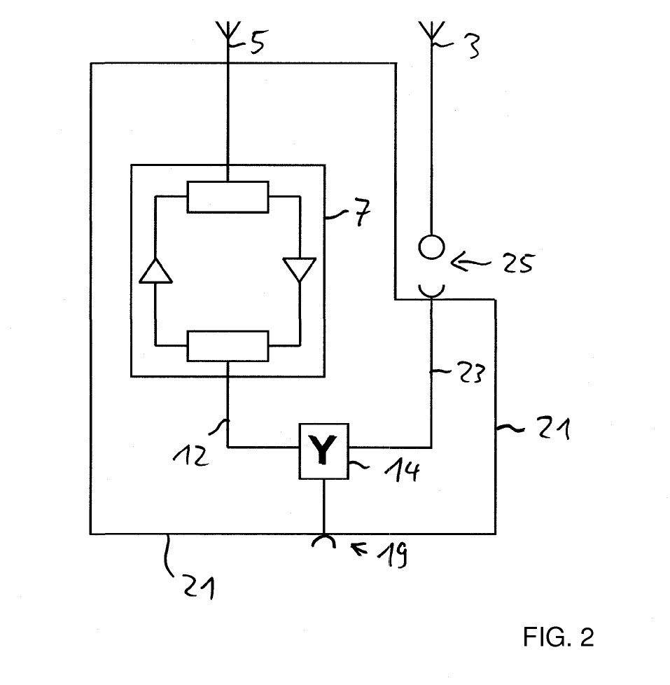

FIG. 2 shows a variant of the device shown in FIG. 1, wherein a second antenna is not, as in the embodiment in FIG. 1, disposed in a fixed manner on the device, but is connected via a cable plug-in connection to the device,

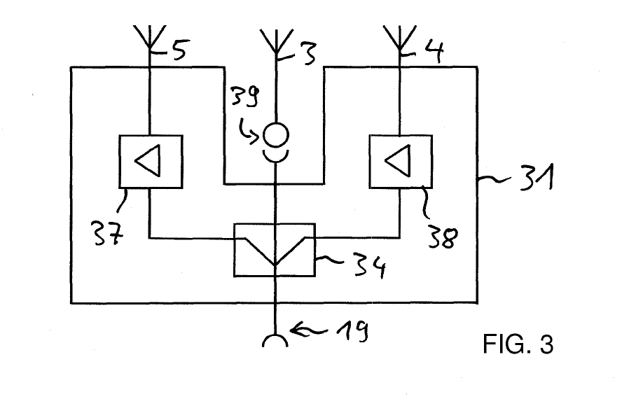

FIG. 3 shows a third variant of a device for transmitting and receiving radio signals,

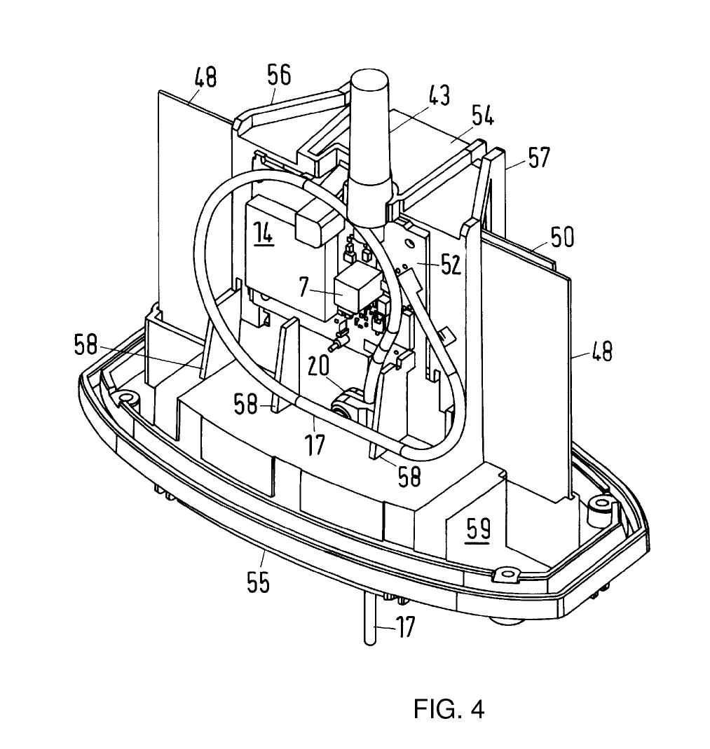

FIG. 4 shows a three-dimensional representation of a specific embodiment, for example, of the device shown in FIG. 1,

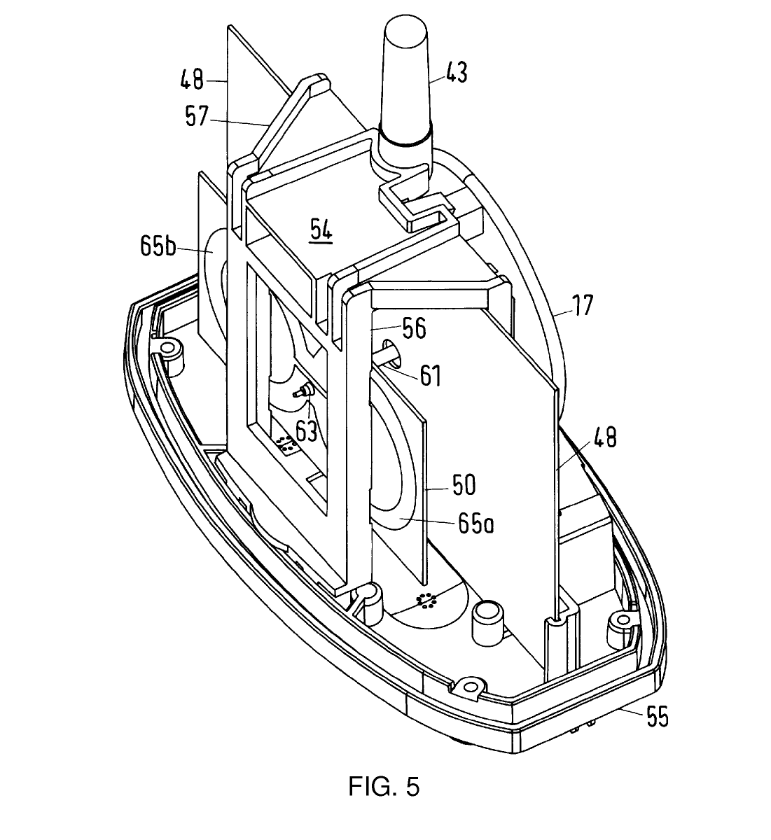

FIG. 5 shows a three-dimensional representation of the device shown in FIG. 4 from an opposite side,

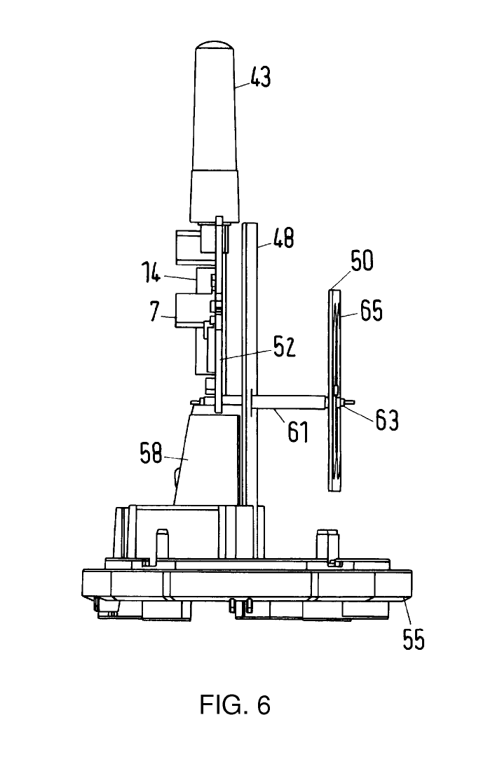

FIG. 6 shows a side view of the device shown in FIGS. 4 and 5, wherein parts of the device are left out to provide a completely unobscured view of other parts, and

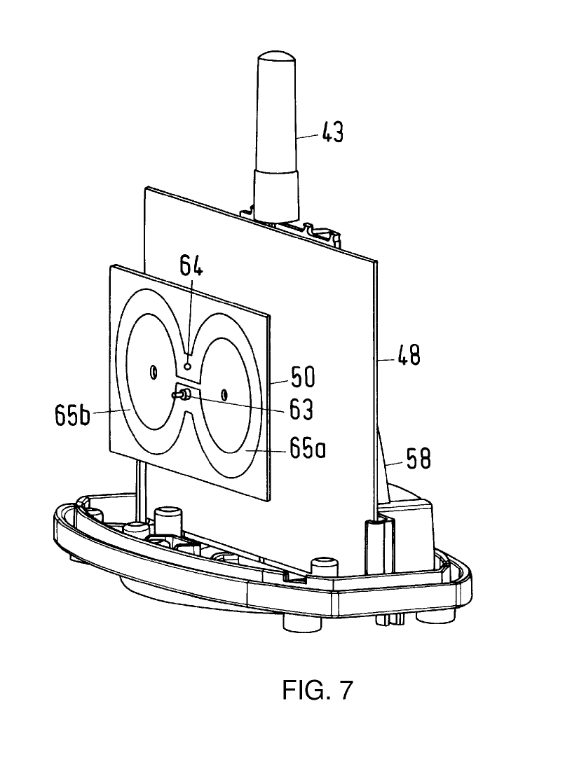

FIG. 7 shows a three-dimensional view, from an angle of view similar to that of FIG. 5, of the device shown in FIGS. 4 to 6, wherein, however, similar to FIG. 6, parts have been left out.

FIG. 1 shows a circuit diagram of a device 1 for transmitting and receiving radio signals. The device 1 has two antennas 3, 5, of which a first antenna 5 is a transmit and receive antenna for transmitting radio signals in a first frequency range, for example around 2100 MHz for communication in a UMTS radio network. The second antenna 3 is a transmit and receive antenna for transmitting and receiving radio signals in a different frequency range, for example around 900 MHz for communicating in a GSM radio network. A radio terminal device can be connected via a coupling device 18, a radio-frequency cable (e.g. coaxial cable) 16 with corresponding plug-in connectors and via an input line 17 to a radio signal filter 14 of the device 1. The plug-in connections of the cable 16 to the coupling device 18 are designated with the reference number 20, the plug-in connections of the cable 16 to the connection line 17 with the reference number 19. The connection line 17 of the device 1 or the input of the cable 17 into the radio signal filter 14 or the cable plug-in connection of the plug-in connection 19 can be designated as a common cable connection of the antennas 3, 5.

The radio signal filter 14 is connected via a first radio-frequency line 12 to an amplifier circuit 7. Furthermore, a different output of the radio signal filter 14 is connected to a second radio-frequency line 15, which is connected to the second antenna 3. In this example embodiment, no amplification of radio signals takes place between the radio signal filter 14 and the second antenna 3. The amplification circuit 7 in the radio signal path between the radio signal filter 14 and the first antenna 5 has a first amplifier 10 to amplify signals to be transmitted, and a second amplifier 11 to amplify received signals. From the perspective of the radio signal filter 14 at the input of the amplifier circuit 7, a first filter 8 is located which allows the signals to be transmitted to pass into the branch with the transmit amplifier 10. From the perspective of the transmit amplifier 10 in the direction of the first antenna 5, i.e. on the output side of the first amplifier 10, a further, second filter 9 is located which allows the amplified signals which are to be transmitted to pass into a radio-frequency connection line 13 to which the antenna 5 is connected.

Signals received by the antenna 5 are similarly forwarded via the connection line 13 to the second filter 9. These received signals are fed through by the second filter 9 into the branch of the amplification circuit 7 in which the second amplifier 11, the receive amplifier, is located. The amplified received signals are fed to the first filter 8, which allows them to pass into the line 12 to the radio signal filter 14. There, they are forwarded into the connection line 17 on the terminal-device-side connection of the device 1 and can pass via the cable 16 to the coupling device 18.

The coupling facility 18 may, for example, directly involve the input of the radio terminal device, if it has a cable plug-in connection, for example a coaxial cable socket. However, the coupling facility 18 may also involve a coupling facility for the wireless coupling of radio signals via one or more antennas, wherein these one or more antennas are designed to be coupled in the near field to a transmit and receive antenna of the terminal device.

Due to the amplifier circuit 7, the device 1 enables reliable communication at a high data transmission rate between the terminal device and a radio network which has a small network coverage and in which the attenuation of the radio transmission to the most readily contactable transmit and receive station of the radio network is relatively high. Conversely, communication can take place with a different radio network with a lower attenuation, for example with a greater cell density, via the second antenna 3 without amplification. In particular, the communication can take place simultaneously into both radio networks. Thus, for example, an image data transmission is possible via the UMTS network, while a user makes a telephone call with the terminal device via a GSM network.

However, the invention is not restricted to a device with only two antennas for communication in various radio networks. It may also occur that the radio communication via the first antenna 3 is more strongly attenuated, so that an amplification similar to the amplification circuit 7 in the signal path to the first antenna is desirable. The variant shown in FIG. 2 is suitable for such a situation. The same reference numbers designate the same elements as in FIG. 1.

As with the device 1 in FIG. 1, the device 21 has a first antenna 5 and a second antenna 3. As shown in FIG. 1, an amplification circuit 7 is similarly disposed in the signal path between the first antenna 5 and the radio signal filter 14. However, a cable plug-in connection 25, which enables an intermediate connection of an optionally used amplifier, similar to the amplification circuit 7 in the other signal path, is provided in the signal path between the radio signal filter 14 and the second antenna 3. In this case, the optionally provided amplifier preferably also has a transmit amplifier and a receive amplifier and a filter, as shown in FIG. 1 for the other signal path. However, the amplifiers are designed for the frequency range in which the second antenna 3 transmits and receives radio signals. Furthermore, the optional amplifier can be connected on the terminal-device side to the connection line 23 of the device 21, which in this case connects it to the radio signal filter 14. Furthermore, the antenna 3 can be connected to the amplifier on the radio-network side.

FIG. 3 shows a design of a device 31, which is designed in a similar way to the devices 1, 21 in FIGS. 1 and 2. However, this device 31 has three antennas 3, 4, 5, which are designed in each case for communication in various frequency ranges into radio networks. A connection of a terminal device is in turn possible via a cable plug-in connection 19 on the terminal-device-side input of the device 31, in particular via a cable. The connection 19 leads to a radio signal filter 34 which, however, has three outputs on the radio-network side. This filter 34 splits the radio signals arriving from the terminal device into three parts, wherein the divided signals have a lower signal strength than the input signal. An amplifier circuit 37, which is, in particular, designed in exactly the same way as the amplifier circuit 7 in FIG. 1, is located in the signal path from the filter 34 to the first antenna 5. An amplifier circuit 38, which may in turn be designed in the same way as the amplifier circuit 7 in FIG. 1, but wherein the amplifiers are designed for the frequency range of the third antenna 4, is similarly located in the signal path from the filter 34 to the third antenna 4. As in FIG. 2, the second antenna 3 is connected via a plug-in connection 39 to the filter 34.

Further variants of the device are possible. In particular, a different number of antennas can be connected via the filter. Depending on the design, it is in fact possible to provide or not to provide an amplifier circuit in each signal path between the filter and the respective antenna. If no amplifier circuit is provided in a signal path, the latter can optionally be retrofitted with an amplifier, in particular if the antenna is connected via a plug-in connection to the filter. The filter does not have to be a single component. Instead, it may also be a cascade of splitters/combiners.

A specific example embodiment of a device with two antennas will now be described with reference to FIGS. 4 to 7. However, the principle shown therein of the use of a directional antenna with high antenna gain in relation to an isotropic radiator and/or the principle of the shielding of the two antennas from one another can also be used in other devices which may, for example, also have more than two antennas, as shown in FIG. 3, for example.

The device shown in FIGS. 4 to 7 has a base 55, on which a housing cover can be placed. However, to provide an unobstructed view of the further design of the device, the cover is not shown in FIGS. 4 to 7.

The three-dimensional representation in FIG. 4 shows the inside of the device from a first side. A plate-shaped part is recognizable, which extends transversely through the inside of the device, wherein the large-area surfaces of the plate-shaped part are aligned with their normal lines in a horizontal direction. However, the horizontal direction relates only to the representation in FIGS. 4 to 7. The device may also be differently oriented in use. The plate-shaped part is a reflector 48 which is made, for example, from metal, and reflects radio waves in at least one frequency range in which radio signals are transmitted and received by one of the antennas of the device. In particular, the reflector 48 is designed for the reflection of radio waves which are transmitted and received by the directional antenna which has still to be described in detail and which is applied onto the carrier 50 disposed in the background in FIG. 4. This plate-shaped carrier 50 extends parallel to the reflector 48.

In the foreground of the representation in FIG. 4, in front of the reflector 48, a motherboard 52 is recognizable on which an electrical circuit is set up with corresponding components, of which two are designated with the reference numbers 7, 14. These reference numbers 7, 14 have the same meaning as in FIG. 1, i.e. the reference number 7 designates the amplifier circuit and the reference number 14 designates the radio signal filter. Furthermore, the reference number 17 designates a connection cable which connects a terminal device to the radio signal filter 14. However, in contrast to FIG. 1, the cable 16 to be connected via plug-in connections 19, 20 has been left out and the cable 17 passes through from the radio signal filter 14 to the coupling facility 18 of the terminal device. This has the advantage that the attenuation of the connection cable 17 is fixed and the amplification power of the amplifier circuit 7 can be tuned to this attenuation. For example, a cable 17 of this type may have an attenuation of 20 dB and the amplification power of the amplifier circuit 7 in each case in the transmit path and in the receive path is 22 dB.

FIG. 4 shows further parts 54, 56, 57, 58, preferably made from plastic, which are used for the mechanical fixing or support of the aforementioned motherboard 52, the reflector 48 and the carrier 50. In FIG. 4, a strain relief 20 is furthermore recognizable which has a passage opening through which the connection cable 17 extends, wherein the strain relief 20 clamps the cable 17 in place, thereby effecting a strain relief.

The three-dimensional representation in FIG. 5 shows the structure from FIG. 4 of a different, opposite-lying side of the reflector 48. The carrier 50, which carries conductor paths 65a, 65b made from electrically conducting material, can therefore be recognized in the foreground to the left of the reflector 48. The conductor paths 65a, 65b in each case encircle a circular area on the surface of the carrier 50. However, the circular area is not encircled by the conductor paths 65a, 65b in a closed manner. Starting from the feed point 63 to which the conductor path 65 is connected via a connection line 61 for the input and output of radio-frequency signals, the conductor paths 65a, 65b encircle the circular areas virtually completely, but without closing the circular ring. Following the circulation, they reach the second connection point 64 to which the shielding of the connection line 61 is connected. The feed point and connection point for the shielding can also be transposed. In other words, an end area of the circular ring-shaped conductor path 65a, 65b is located in each case opposite the feed point 63 in the representation at the top of FIG. 5, said end area being separated by a narrow area made from non-conducting material, wherein this isolating area is formed by the material of the carrier 50.

However, the two conductor paths 65a, 65b are electrically interconnected there, so that, starting from the feed point 63 following an encirclement around one of the circular areas, a transition takes place to the other conductor path which encircles the other circular area and returns to the feed point 63. Unlike the design shown in FIGS. 5 and 7, differently shaped encircled areas rather than circular encircled areas may be involved. For example, the areas may be square.

As mentioned, the feed point 63 is connected to a connection line 61, which connects the feed point 63 to the amplifier circuit 7 on the motherboard 52. This connection line 61 leads through a passage opening of the reflector 48 through the latter, wherein the connection line 61 runs perpendicular to the surface of the reflector 48. Since the surface of the carrier 50 onto which the conductor paths 65 are applied also runs parallel to the surface of the reflector 48, a symmetrical arrangement arises which results in a directional characteristic of the antenna which is symmetrical to a perpendicular of the carrier surface, wherein the perpendicular approximately runs through the feed point 63. This antenna is the antenna formed by the conductor paths 65. Due to the described configuration, the antenna has a pronounced directional effect with an antenna gain of more than 5 dBi.

This antenna is the antenna corresponding to the first antenna 5 in the device 1 according to FIG. 1. The second antenna 43 of the device shown in FIGS. 4 to 7 corresponds to the second antenna 3 in FIG. 1. This second antenna 43 is a rod antenna with a rod longitudinal axis which extends in a perpendicular direction and parallel to the surface of the reflector 48. It is recognizable from FIG. 4 that the rod antenna 43 runs with its longitudinal axis in the plane of the motherboard 52. Although the rod antenna 43 projects beyond the upper edge of the reflector 48, the reflector 48 results in an effective isolation of the two antennas in relation to a possible feedback. The pronounced directional effect of the antenna set up on the carrier 50 furthermore contributes to the isolation.

The basic principle of the combination of a directional antenna and a reflector can therefore be described as follows: if the directional antenna is applied onto a carrier with an even surface, the latter has a direction with maximum antenna gain in relation to the isotropic radiator, wherein the direction preferably runs perpendicular to the even surface of the carrier. Since, in this case, a maximum sensitivity of the antenna to receive signals and the maximum antenna gain exists in principle in both directions along the perpendiculars, the reflector is disposed on one side of the carrier, the surface of which extends parallel to the surface of the carrier. As a result, the maximum receive sensitivity of the antenna or the maximum antenna gain exists only on one side along the perpendiculars onto the even surface of the carrier. The entire half-area from the perspective of the carrier beyond the reflector is now available for the communication with the second antenna. Furthermore, a part of the half-area is also available for the communication of the second antenna with a radio network.

The structure of the device can again be recognized from the side view shown in FIG. 6. The direction of view of the representation in FIG. 6 is horizontal and the perpendicular of the figure plane runs parallel to the even surface of the carrier 50 and parallel to the large-area surfaces of the reflector 48. The carrier 50 is recognizable on the right, wherein the conductor paths 65 are applied to the surface of the carrier 50 located to the right in FIG. 6. From the feed point 63, the connection line 61 extends through a passage opening in the reflector 48 through to the motherboard 52, on which the elements of the amplifier circuit and the filter are set up. The rod antenna 43 extends upwards from the upper edge of the motherboard 52.

The design of the conductor paths 65a, 65b, which have already been described with reference to FIG. 5, is very easily recognizable from FIG. 7, which provides a completely unobstructed view of the surface of the carrier 50.

1-12. (canceled)

13. A device for transmitting and receiving radio signals, the device comprising:
at least two antennas including a first antenna for at least transmitting the radio signals and at least one second antenna for at least receiving the radio signals, said antennas transmitting and receiving the radio signals in each case in a different frequency range;
a common cable connection;
a frequency filter, each of said antennas connected via said radio signal filter to said common cable connection via which the device can be connected to a radio terminal device;
at least one radio signal amplifier including at least one of a first radio signal amplifier disposed in a first radio signal path between said radio signal filter and said first antenna and of a second radio signal amplifier disposed in a second radio signal path between said second antenna and said radio signal filter; and
said first antenna and said second antenna having an attenuation in relation to a feedback of a radio signal transmitted from said first antenna to said second antenna due to an arrangement thereof relative to one another and due to transmit characteristics and receive characteristics thereof, the attenuation being greater than an amplification gain of said first and second radio signal amplifiers, minus an attenuation which said frequency filter has in relation to crosstalk of signals between the first and second radio signal paths.

14. The device according to claim 13, wherein only either said first radio signal amplifier or said second radio signal amplifier is provided, so that the attenuation is greater than the amplification gain of said radio signal amplifier provided, minus the attenuation which said frequency filter has in relation to the crosstalk of the signals between the first and second radio signal paths.

15. The device according to claim 13, wherein one of said first and second antennas is a directional antenna with an antenna gain of more than 5 dBi.

16. The device according to claim 13, wherein one of said first and second antennas is an antenna which has a carrier and an electrically conducting layer which is applied onto an even surface of said carrier.

17. The device according to claim 16, wherein said electrically conducting layer has two strip lines, which in each case encircle an area of said even surface.

18. The device according to claim 16, further comprising a plate-shaped reflector made from an electrically conducting material and having two parallel large-area surfaces corresponding to a plate shape which run parallel to said even surface of said carrier, wherein said plate-shaped reflector, seen from said electrically conducting layer, is disposed on a rear side of said carrier.

19. The device according to claim 18, wherein, seen from said carrier, the other of said first and second antennas is disposed on said rear side of said plate-shaped reflector.

20. The device according to claim 19, wherein the other antenna is a rod antenna, which projects on said rear side of said plate-shaped reflector beyond edges of said plate-shaped reflector, so that said rod antenna is visible from a front side of said plate-shaped reflector.

21. The device according to claim 18, wherein, seen from said carrier, said radio signal filter and said radio signal amplifier are disposed on said rear side of said plate-shaped reflector.

22. The device according to claim 21, wherein said radio signal path between said radio signal filter and said electrically conducting layer has a radio signal line on said even surface of said carrier which is fed perpendicular to said large-area surfaces of said plate-shaped reflector through said plate-shaped reflector.

23. The device according to claim 13, wherein one of said first and second antennas is a directional antenna with an antenna gain of more than 7 dBi.

24. A method for transmitting and receiving radio signals, which comprises the steps of:
providing a device having at least two antennas including a first antenna for at least transmitting radio signals, and at least one second antenna for at least receiving the radio signals, the antennas transmitting and receiving the radio signals in each case in a different frequency range;
transmitting the radio signals, if the radio signals are received at a specific time, from a respective one of the antennas via a frequency filter to a common cable connection of the antennas, or, if the radio signals are transmitted at the specific time, the radio signals are transmitted from the common cable connection via the frequency filter to a respective one of the antennas;
amplifying the radio signals in at least one radio signal path between the frequency filter and the respective antenna, wherein the radio signals are amplified in a first radio signal path between the radio signal filter and the first antenna by a first radio signal amplifier, and/or the radio signals are amplified in a second radio signal path between the second antenna and the radio signal filter by a second radio signal amplifier; and
the first antenna and the second antenna cause an attenuation of the radio signals in relation to a feedback of a radio signal transmitted from the first antenna to the second antenna due to an arrangement thereof relative to one another and due to at least one of a transmit characteristic or a receive characteristic thereof, the attenuation being greater than an amplification gain of the first and second radio signal amplifiers, minus an attenuation which the radio signal filter has in relation to crosstalk of signals between the radio signal paths.

25. A method for manufacturing a device for transmitting and receiving radio signals, which comprises the steps of:
producing at least two antennas including a first antenna for at least transmitting radio signals, and at least one second antenna for at least receiving the radio signals, and the antennas are directly or indirectly mechanically interconnected;
configuring the antennas to transmit and receive the radio signals in each case in a different frequency range;
connecting each of the antennas via a radio signal filter to a common cable connection, via which the device is connectable to a radio terminal device; and
providing at least one radio signal amplifier including at least one of a first radio signal amplifier disposed in a first radio signal path between the radio signal filter and the first antenna or a second radio signal amplifier disposed in a second radio signal path between the second antenna and the radio signal filter, the first antenna and the second antenna, in relation to feedback of a radio signal transmitted from the first antenna to the second antenna, are disposed relative to one another and configured such that the antennas have an attenuation being greater than an amplification gain of the first and second radio signal amplifiers, minus an attenuation which the radio signal filter has in relation to crosstalk of signals between the radio signal paths.
